(19) United States
(12) Patent Application Publication
(10) Pub. No.: US 2023/0287945 A1
(43) Pub. Date: Sep. 14, 2023

(54) BRAKE DUST PARTICLE FILTER, DISC BRAKE ASSEMBLY AND METHOD FOR COLLECTING BRAKE DUST PARTICLES

(71) Applicant: MANN+HUMMEL GmbH, Ludwigsburg (DE)

(72) Inventors: Florian KELLER, Ludwigsburg (DE); Lukas BOCK, Bietigheim-Bissingen (DE); Steffen PFANNKUCH, Ludwigsburg (DE); Tobias WÖRZ, Leutenbach (DE); Martin LEHMANN, Karlsruhe (DE); Thorsten SCHMID, Schwaikheim (DE); Ashish SATISH CHANDRA, Bangalore (IN); Pravesh YERAYAVAKKATH PRABHAKAR, Bangalore (IN)

(21) Appl. No.: 18/008,178

(22) PCT Filed: Oct. 8, 2020
(86) PCT No.: PCT/EP2020/078209

§ 371 Date: Dec. 5, 2022

(30) Foreign Application Priority Data
Oct. 28, 2019 (IN) 201921043688

(51) Int. Cl. F16D 65/00

(52) U.S. Cl. CPC F16D 65/0031

(57) ABSTRACT

A brake dust particle filter for a disc brake assembly with a brake disc and a brake caliper is provided, the brake dust particle filter being configured to collect particles resulting from braking, wherein the brake dust filter comprises:
a housing comprising a first and a second side wall which are arranged opposite to each other and a peripheral wall connecting the first and the second side wall; wherein
the first side wall comprises at least one guiding element protruding towards the second side wall within the housing, the guiding element having a face which is arranged opposite to a peripheral wall section of the peripheral wall; and
the brake dust particle filter is configured to accommodate the brake disc between a distal edge of the guiding element and the second side wall.

### TECHNICAL FIELD

The present invention relates to a brake dust particle filter for collecting brake dust particles resulting from braking. The invention further relates to a disc brake assembly comprising the brake dust particle filter, to a use of the brake dust particle filter and to a method for collecting brake dust particles.

### BACKGROUND

Brake dust particle filter used to collect particles generated when a vehicle brakes are for example known from WO 2019/048374 A1. Such particles, which result from friction between a brake disc and a brake caliper, can be damaging for health and environment. It is hence desirable to improve the filtering of such particles by a brake dust particle filter.

It is one object of the present invention to provide an improved brake dust particle filter. Other objects are the provision of an improved disc brake assembly, of an improved use of the brake dust particle filter and of an improved method for collecting brake dust particles.

### DISCLOSURE OF THE INVENTION

According to a first aspect, a brake dust particle filter for a disc brake assembly with a brake disc and a brake caliper is provided, the brake dust particle filter being configured to collect particles resulting from braking. The brake dust filter comprises:
a housing comprising a first and a second side wall which are arranged opposite to each other and at least one peripheral wall or wall portion connecting the first and the second side wall; wherein
the first side wall comprises at least one guiding element spaced radially from the at least one peripheral wall or wall portion and protruding towards the second side wall within the housing, the guiding element having a face which is arranged opposite to a peripheral wall section of the peripheral wall; and
the brake dust particle filter is configured to accommodate the brake disc between a distal edge respectively “free edge” of the guiding element and the second side wall.

The guiding element may slow down the particles by deviating air carrying the particles coming from the brake disc. Therefore the guiding element may be called “flow guiding element” alternatively. In particular, the air carrying the particles is deviated multiple times inside the housing, for example by the peripheral wall, by the first side wall and by the guiding element. The particles can then spend a longer time inside the brake dust particle filter, thereby increasing the probability that they get projected onto filter medium located in the housing inside. The filtering of the particles may thereby by improved.

The peripheral wall or wall portion extends at least partially over a circumference of the housing. The peripheral wall can have at least one, preferably multiple, cutouts therein. The cutouts being preferably spaced circumferentially individual peripheral wall portions therebetween.

All directional information (e.g. radial, axial tangential) provided herein refers to a rotation direction of a brake disc in an installed state of the brake dust particle filter.

The disc brake assembly, which comprises a brake disc and a brake caliper, can be part of a motorized vehicle such as a car, a truck, a motorcycle, a train, a plane or the like. The disc brake assembly may be used for braking the vehicle on which it is arranged. In particular, the disc brake assembly is arranged on a wheel of the vehicle, for example on a front wheel. In some embodiments, both front wheels or every wheel of the vehicle is provided with such a disc brake assembly.

The brake caliper may comprise two brake pads which squeeze the disc brake when the vehicle brakes, thereby creating friction between the brake caliper and the disc brake. Since the disc brake is fixedly arranged on the wheel, the rotation of the wheel is slowed and/or stopped.

When braking force is applied, abrasive friction between the brake pads of the brake caliper and the brake disc wears both the brake disc and the brake pads away, thereby generating dust particles (also referred to as particles resulting from braking or as brake dust).

In its mounted position, the brake dust particle filter can be arranged after the brake caliper in a forward rotation direction of the wheel to which the brake caliper is attached, the forward rotation direction corresponding to a direction in which the wheel (and the brake disc) rotates when the vehicle drives forward. Thereby, the particle dust resulting from braking can be moved towards the brake dust particle filter for filtration.

In particular, the motion of the particles can be influenced by an air flow coming from the brake disc. In detail, the brake disc may generate such an air flow when the brake disc is a ventilated disc comprising two disc faces and an edge with openings creating an air channel and allowing an air flow therebetween. In this case, the air flow from the brake disc can push or carry the particle.

The brake dust particle filter may comprise an open (non-closed) housing in order to place it on the disc brake and collect a great particle amount. Collecting particles here for example means that the particles get trapped in the brake dust particle filter, in particular on the filter medium. At least part of the housing interior may be covered with a filter medium for collecting the particles. It is desirable that the particles remain in the brake dust particle filter as long as possible and/or over a particle travel distance which is as great as possible, to increase the probability of contact between the particles and the filter medium and improve the filtering of the particle dust.

This is for example achieved with the guiding element. Indeed, the guiding element may be positioned in the housing interior such that an air flow from the brake assembly, which also holds the dust particles to be filtered, is deviated by the guiding element. Deviation here means that a direction of the deviated particles and/or air is changed, in particular by at least 90°. This deviation can advantageously slow down the particles which thus remain in the brake dust particle filter for a longer time, thus improving the filtering.

In detail, the housing includes the first and second side walls opposing each other. In particular, the first and second side walls are (mostly) parallel to each other. The first and second side walls are connected by a bridging peripheral wall, which in particular connects two edges of the side walls to each other. Viewed from aside, the two side walls and the peripheral wall may form a U-shaped housing. In particular, the first side wall and the second side wall may each be perpendicular to the peripheral wall. The housing can be open on a side opposing the peripheral wall, thereby forming a slot for inserting the disc brake, the disc brake thus being arranged between the first and second side walls in a mounted state. The housing may be formed integrally. Connecting in particular means forming an airtight connection.

The housing may be made of a heat resistant material such as metal sheets (in particular steel sheets) or high temperature resistant plastic since it can get exposed to temperatures as high as 800° C. in the braking process. In particular, all parts of the housing, including the guiding element, can be formed of the same material. Alternatively the guiding element(s) can be made of a differing material, e.g. from a filter medium. The interior of the housing can be partly or entirely coated with a filter medium. The filter medium may also be high-temperature resistant (in particular, up to 800° C.). The filter medium may include metal, glass, metal fiber fleece, high temperature resistant plastic or the like.

The first side wall includes the guiding element, which may be integrally formed therewith. The guiding element, which may also be referred to as a blade, rib, vane or fin, in particular has two faces and a distal edge. The distal edge may be the edge of the guiding element which is furthest away from the first side wall from which the guiding element extends. The two faces of the guiding element may be parallel to each other. One of the faces of the guiding element can be arranged opposite to the peripheral wall, in particular to a section of the peripheral wall section referred to as peripheral wall section. In particular, this face is a planar face.

The guiding element may protrude towards the second side wall such that its distal edge is arranged opposite to the second side wall. In the mounted state, the brake disc may be arranged between the distal edge and the second side wall. In particular, in the mounted state, the guiding element may protrude towards the brake disc arranged between the first and second side walls. In some embodiments, the guiding element is configured to guide the particles within the brake dust particle filter, as will be described in greater detail below.

Advantageously, the particles resulting from braking may be pushed towards the guiding element, which slows down the particles. For example, the guiding element slows down the particles by deviating the air carrying the particles (deceleration). In particular, the air carrying the particles is deviated multiple times inside the housing, for example by the peripheral wall, by the first side wall and by the guiding element.

The particles then spend a longer time inside the brake dust particle filter, thereby increasing the probability that they get projected onto filter medium located in the housing inside. The filtering of the particles may thereby by improved.

According to an embodiment, the peripheral wall section is adjacent to a first side wall section from which the guiding element protrudes. In particular, the peripheral wall section is the portion of the peripheral wall which is closest to the guiding element and closest to the first side wall section on which the guiding element is provided.

According to a further embodiment, a housing interior is formed by the first side wall, the second side wall, the peripheral wall and at least one additional peripheral wall of the housing, the guiding element being arranged radially between the peripheral wall and the additional peripheral wall. In particular, the additional peripheral wall comprises two sections, forming a slot for inserting the brake disc therebetween. The guiding element may be formed on an interior of the housing. In particular, the guiding element is not formed on an edge of the housing.

According to a further embodiment, the face of the guiding element extends in parallel to the peripheral wall section, in particular in a circumferential direction. In particular a radial distance between the peripheral wall and the guiding element is constant.

According to a further embodiment, the guiding element has a bent shape. In particular, the guiding element is not straight and can have a circular or near-circular shape. Rather, it may for example have a ring segment shape.

According to a further embodiment, the housing has a ring segment shape, the first and second side walls extend along a radial direction of the ring segment, the peripheral wall extends along a circumferential direction of the ring segment, and the guiding element protrudes in an axial direction of the ring segment.

In particular, the guiding element has a ring segment shape which has the same radius as the housing ring segment.

According to a further embodiment, the second side wall also comprises a guiding element protruding towards the first side wall, the guiding element of the second side wall having a face which is arranged opposite to a peripheral wall section of the peripheral wall.

In particular, at least one guiding element is provided on both the first and second side wall. The housing may be symmetric regarding the arrangement of the guiding elements. In the following, the expression “guiding element” may equally refer to the guiding element of the first side wall or to the guiding element of the second side wall. In cases where a distinction needs to be made, the expressions “guiding element of the first side wall” and “guiding element of the second side wall” will be used. The embodiments of the guiding element described with respect to the first side wall also apply for the guiding element of the second side wall.

According to a further embodiment, the guiding element or guiding elements of the first side wall flush with the guiding element or guiding elements of the second side wall. The guiding elements on the first side wall and the second side wall “flush” if they are arranged directly opposing axially, i.e. having the same radial positioning. In particular, the guiding element(s) of the first side wall is arranged at a same distance from the peripheral wall as the guiding element(s) of the second side wall. The resulting housing can thereby be symmetric regarding the arrangement of the guiding elements.

According to a further embodiment, the housing further comprises a partition element connecting two guiding elements, the partition element having a face arranged opposite to the first side wall such that a channel is formed between the first side wall, the partition element and the two neighboring guiding elements.

In particular, the partition element may couple the distal edges from the two connected guiding elements. The channel can be used to guide the particles within the filter, in particular to improve a travel path of the particles inside the filter. The partition element may be part of the housing, and in particular may be made of the same material.

In an alternative embodiment the housing comprises a partition element connecting at least one guiding element and a peripheral wall. The partition element having a face arranged opposite to the first side wall such that a channel is formed between the first side wall, the partition element, the at least one guiding element and the peripheral wall.

In an especially preferred embodiment the partition element extends parallel to the first side wall.

According to a further embodiment, the first side wall further comprises a side element connected to the first guiding element and extending past a lateral edge of the second guiding element such as to form a passage between the end of the second guiding element and the side element of the first guiding element.

The lateral edge or circumferential edge may be an end of the guiding element along a circumferential direction. The first guiding element and the second guiding element can be neighboring guiding elements. The arrangement with the first and second guiding elements, the side element and the side element forms a channel with a passage for allowing air to flow into the channel. The guiding element and the side element may form a labyrinth which deviates the air flowing through the brake dust particle filter, thereby increasing the filtering of the dust particles. In some further embodiments, several side elements may be provided. The side element may be part of the housing, and in particular may be made of the same material.

Additionally or alternatively the side element can be connected to the peripheral wall and/or the additional peripheral wall as well. The side element preferably extends in a radial or near-radial direction.

According to a further embodiment, the distance from the peripheral wall section to the face of the first guiding element is larger than the distance from the peripheral wall section to the face of the second guiding element. In other words, the second guiding element may be closer to the peripheral wall than the first guiding element.

According to a further embodiment, a height of the first side wall corresponds to a radial extension of the housing, the distance between the guiding element and the peripheral wall section being less than one third of the height of the first side wall. In particular, the guiding element is arranged in the lower third of the first side wall when departing from the portion of the first side wall connected to the peripheral wall.

According to a further embodiment, the brake dust particle filter comprises a filter medium for collecting the particles, the filter medium extending at least on a part of a housing interior formed between the first and second side walls. In some embodiments, the filter medium may be provided on one or both of the faces of the guiding elements.

According to a further embodiment, the brake dust particle filter comprises a slot for accommodating the brake disc in the installation state formed between the first and second side wall. In particular, the slot is one formed in the additional peripheral wall.

According to a second aspect, a disc brake assembly with a brake disc, a brake caliper and a brake dust particle filter according to the first aspect or according to an embodiment thereof is provided, wherein the brake disc extends between the distal protruding edge of the guiding element and the second side wall.

The embodiments and features described with reference to the brake dust particle filter according to the first aspect or according to an embodiment thereof apply mutatis mutandis to the disc brake assembly of the second aspect.

According to an embodiment, the brake dust particle filter is arranged in a fixed position relative to the brake caliper. In particular, the brake dust particle filter is unmovably attached to the brake caliper.

According to a further embodiment, the brake disc is a ventilated disc comprising two disc faces and a circumferential edge with openings allowing an air flow therethrough, the openings in the edge being arranged opposite to the peripheral wall. Ventilated discs may be advantageous for cooling the brake assembly during the braking process since they allow for an air flow. The air flowing through the openings may be an air flow radially outwards from the brake disc. It may be an air flow holding the dust particles generated when braking and can direct the dust particles. Since the openings in the edge of the brake disc are arranged opposite to the peripheral wall, the outcoming air with the particles may be projected onto the peripheral wall and then deviated by the connecting first side wall and the guiding element thereof.

According to a preferred embodiment the guiding element is configured to force air flowing out of the ventilated disc with a radial flow component into at least one vortex, in particular a vortex having a tangential rotation direction.

According to a further preferred embodiment, the guiding element is configured to deviate air flowing out of the ventilated disc at least three times. The three deviations may be a radial deviation by the peripheral wall (towards the first and second side walls), an axial deviation by the first side wall (towards the guiding element), and a radial deviation by the guiding element (back towards the peripheral wall). These deviations may slow down the particle flow, thereby increasing the probability of the particles being collected by the filter medium.

According to a further embodiment, a predefined gap is provided between the distal edge and the brake disc. In particular, a gap is formed between the distal edge and the brake disc in a radial direction.

According to a third aspect, a use of the brake dust particle filter according to the first aspect or according to an embodiment thereof is provided, the brake dust particle filter comprising a housing with a first and a second side wall which are arranged opposite to each other and a peripheral wall connecting the first and the second side wall; wherein
the first side wall comprises at least one guiding element protruding towards the second side wall, the guiding element having a face which is arranged opposite to a peripheral wall section of the peripheral wall; and
the brake dust particle filter being arranged such that a brake disc is arranged between a distal edge of the guiding element and the second side wall.

The embodiments and features described with reference to the brake dust particle filter according to the first aspect or according to an embodiment thereof apply mutatis mutandis to the use of the brake dust particle filter of the third aspect.

According to an embodiment, the brake dust particle filter is arranged after the brake caliper in a forward rotation direction of the brake disc. Upon rotation of the wheel to which the brake caliper and brake disc are attached, the particles are projected forward along the rotation direction. Therefore, placing the brake dust particle filter after the brake caliper in a forward rotation direction of the brake disc can be advantageous because a larger proportion of the particles thus enter the housing of the brake dust particle filter.

According to a fourth aspect, a method for collecting dust particles resulting from braking is provided. The method comprises:
decelerating dust particle contaminated air emitted from openings in an edge of a ventilated brake disc at a peripheral wall of a brake dust particle filter, at a first side wall of the brake dust particle filter and at a guiding element of the brake dust particle filter; and
guiding the dust particle contaminated air.

According to an embodiment, the method further comprises: adsorbing the decelerated dust particles using a filter medium provided on a housing interior of the brake dust particle filter.

The embodiments and features described with reference to the brake dust particle filter according to the first aspect or according to an embodiment thereof apply mutatis mutandis to the method of the fourth aspect.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

### BRIEF DESCRIPTION OF THE FIGURES

FIG. 1 shows a perspective view of a disc brake assembly according to a first embodiment;

FIG. 2 shows a front view of the disc brake assembly according to the first embodiment;

FIG. 3 shows a side view of the disc brake assembly according to the first embodiment;

FIG. 4 shows a brake dust particle filter according to a first embodiment;

FIG. 5 shows a schematic front view representation of a brake dust particle filter according to a second embodiment;

FIG. 6 shows a perspective view of the brake dust particle filter according to the second embodiment;

FIG. 7 shows a perspective view of the brake dust particle filter according to the first embodiment;

FIG. 8 shows a cut view of the brake dust particle filter according to the first embodiment;

FIG. 9 shows an element arrangement for the brake dust particle filter according to the first embodiment;

FIG. 10 shows another cut view of the brake dust particle filter according to the first embodiment;

FIG. 11 shows a perspective view of the brake dust particle filter according to a third embodiment;

FIG. 12 shows a cut view of the brake dust particle filter according to the third embodiment;

FIG. 13 shows an element arrangement for the brake dust particle filter according to the third embodiment;

FIG. 14 shows another cut view of the brake dust particle filter according to the third embodiment;

FIG. 15 shows a front cut view of a disc brake assembly according to a second embodiment with a brake dust particle filter according to the third embodiment;

FIG. 16 shows a front view of the element arrangement for the brake dust particle filter according to the third embodiment;

FIG. 17 shows a side cut view of a disc brake assembly according to a second embodiment with a brake dust particle filter according to the third embodiment;

FIG. 18 shows a perspective view of the brake dust particle filter according to a fourth embodiment;

FIG. 19 shows a cut view of the brake dust particle filter according to the fourth embodiment;

FIG. 20 shows an element arrangement for the brake dust particle filter according to the fourth embodiment;

FIG. 21 shows another cut view of the brake dust particle filter according to the fourth embodiment;

FIG. 22 shows a front view of the element arrangement for the brake dust particle filter according to the fourth embodiment;

FIG. 23 shows a perspective view of the brake dust particle filter according to a fifth embodiment;

FIG. 24 shows a cut view of the brake dust particle filter according to the fifth embodiment;

FIG. 25 shows an element arrangement for the brake dust particle filter according to the fifth embodiment;

FIG. 26 shows another cut view of the brake dust particle filter according to the fifth embodiment;

FIG. 27 shows a front view of the element arrangement for the brake dust particle filter according to the fifth embodiment;

FIG. 28 shows an element arrangement for a brake dust particle filter according to a sixth embodiment;

FIG. 29 shows a perspective view of the brake dust particle filter according to a seventh embodiment;

FIG. 30 shows a cut view of the brake dust particle filter according to the seventh embodiment;

FIG. 31 shows an element arrangement for the brake dust particle filter according to the seventh embodiment;

FIG. 32 shows another cut view of the brake dust particle filter according to the seventh embodiment;

FIG. 33 shows a front view of the element arrangement for the brake dust particle filter according to the seventh embodiment;

FIG. 34 shows a perspective view of the brake dust particle filter according to an eighth embodiment;

FIG. 35 shows a cut view of the brake dust particle filter according to the eighth embodiment;

FIG. 36 shows an element arrangement for the brake dust particle filter according to the eighth embodiment;

FIG. 37 shows another cut view of the brake dust particle filter according to the eighth embodiment;

FIG. 38 shows a front view of the element arrangement for the brake dust particle filter according to the eighth embodiment.

### EMBODIMENTS OF THE INVENTION

In the Figures, like reference numerals designate like or functionally equivalent elements, unless otherwise indicated.

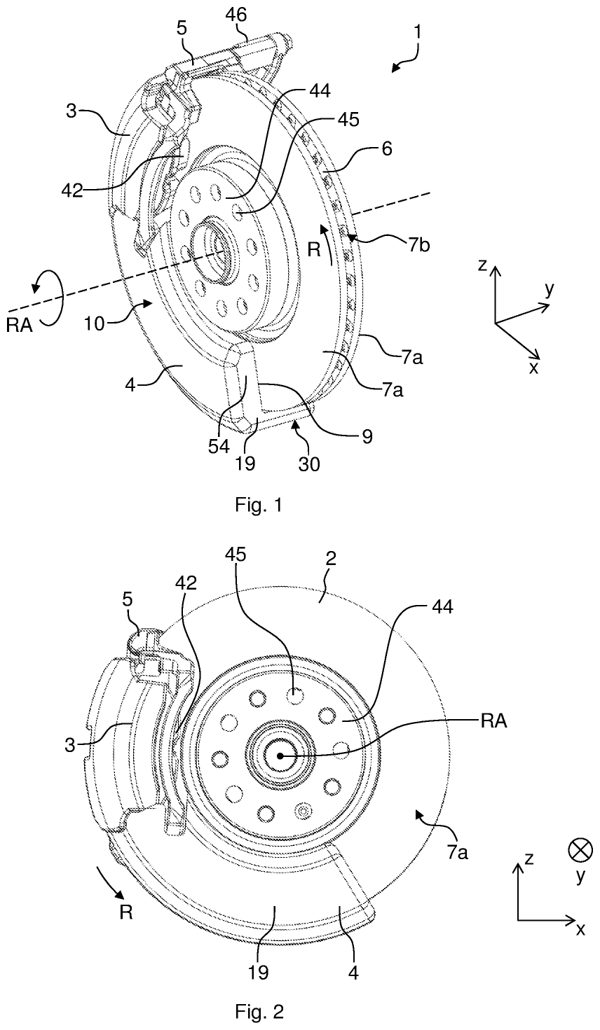

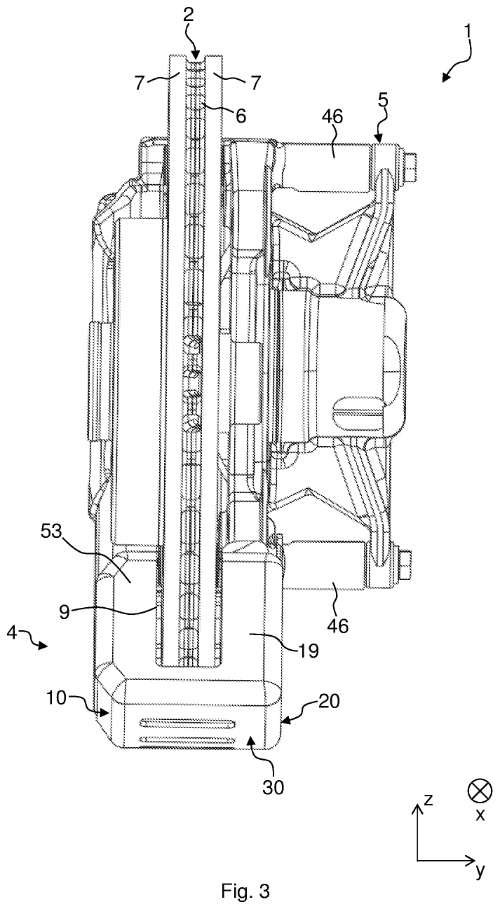

FIGS. 1 to 3 show a disc brake assembly 1 according to a first embodiment. The disc brake assembly 1 comprises a brake disc 2, a brake caliper 3 and a brake dust particle filter 4 (referred to as “filter” in the following) and is meant to be positioned on a wheel of a vehicle (not shown).

The brake disc 2 comprises two faces 7a which are parallel to each other. An outer edge 7b of the brake disc 2 along a radial direction comprises multiple openings 6 for allowing an air flow. The air flow cools the brake disc 2 down during a braking process in order to avoid too high temperatures, for example to avoid temperatures above 700° C.

The brake disc 2 further includes a wheel fixing portion 44 to be attached to the wheel of the vehicle using the screw holes 45. The brake disc 2 thus rotates together with the vehicle wheel in a rotation direction R.

The brake caliper 3 comprises two brake pads 42 which are arranged on either side of the brake disc 2. The brake caliper 3 is fixedly arranged with respect to the vehicle and does not rotate when the wheels rotate. When the vehicle brakes, the brake pads 42 are axially pushed towards the faces 7a of the brake disc 2 by a hydraulic system 46 of a caliper holder 5. The brake pads 42 press the brake disc 2 from both sides along an axial direction parallel to a rotation axis RA of the wheel, thereby slowing down and eventually stopping the rotation of the wheel.

The friction between the brake pads 42 and the brake disc 2 induces abrasion of both the brake pads 42 and the brake disc 2, causing a creation of brake dust particles. The dust particles are moved along the air flow expelled through the openings 6. The dust particles are environmentally damaging and can create health problems. The filter 4 is used to reduce the amount of dust particles released by collecting the created particles.

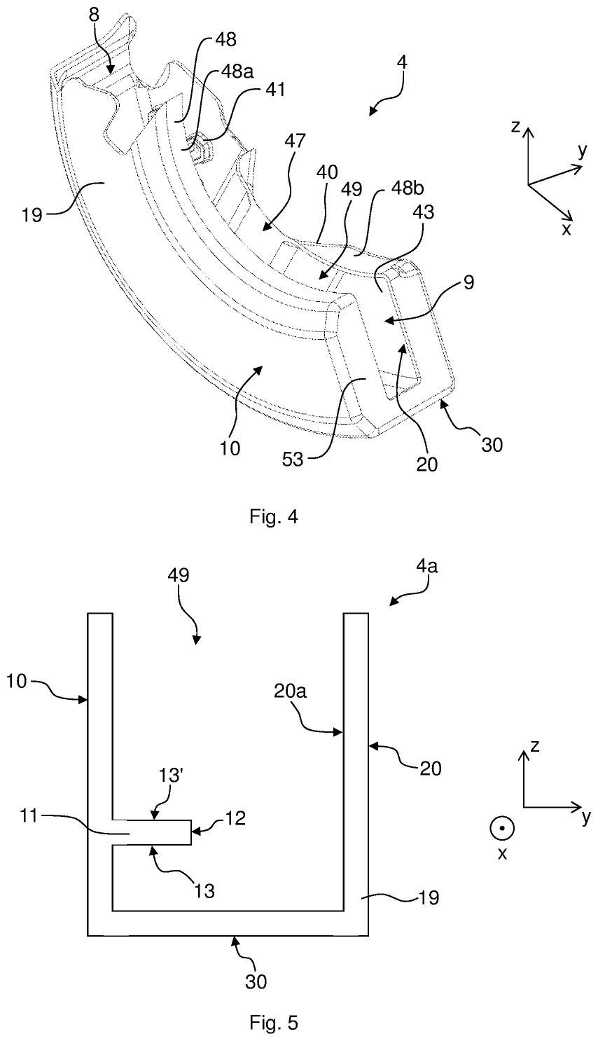

The filter 4 is arranged after the brake caliper 3 in the rotation direction R of the wheel and brake disc 2. It comprises a housing 19 with a first side wall 10, a second side wall 20 and a peripheral wall 30 connecting the two side walls 10, 20, as shown in FIG. 4.

FIG. 4 shows a brake dust particle filter 4 according to a first embodiment, which can be used in the disc brake assembly 1 of FIGS. 1 to 3. As shown in FIG. 4, the housing 19 substantially has a ring segment shape with a slot 47 formed between the first and second side walls 10, 20 which coincides with a shape of the brake disc 2. Namely, the filter 4 is insertable onto the brake disc 2 such that the brake disc 2 extends within the slot 47 and the peripheral wall 30 circumferentially covers edge 7b of the brake disc 2.

In detail, as shown in FIG. 4, the first and second side walls 10, 20 are arranged opposite to each other and mostly parallel. In a mounted state (FIGS. 1 to 3), they extend along the surfaces 7a of the brake disc 2. A bulge 40 is provided on the second side wall 20 for space reasons to allow a rotation of the wheel.

The housing 19 comprises an additional peripheral wall 48 with two portions 48a, 48b each extending inwards towards each other from an edge of the first and second side walls 10, 20. The two side walls 10, 20, the peripheral wall 30, the additional peripheral wall 48 and a lateral wall 54 define a housing interior 49 therebetween.

The housing 19 of the filter 4 is entirely made of steel sheets which can withstand high temperatures occurring at braking. Part of the interior of the housing 19 is covered with filter medium 43 for collecting the particles inside the filter 4.

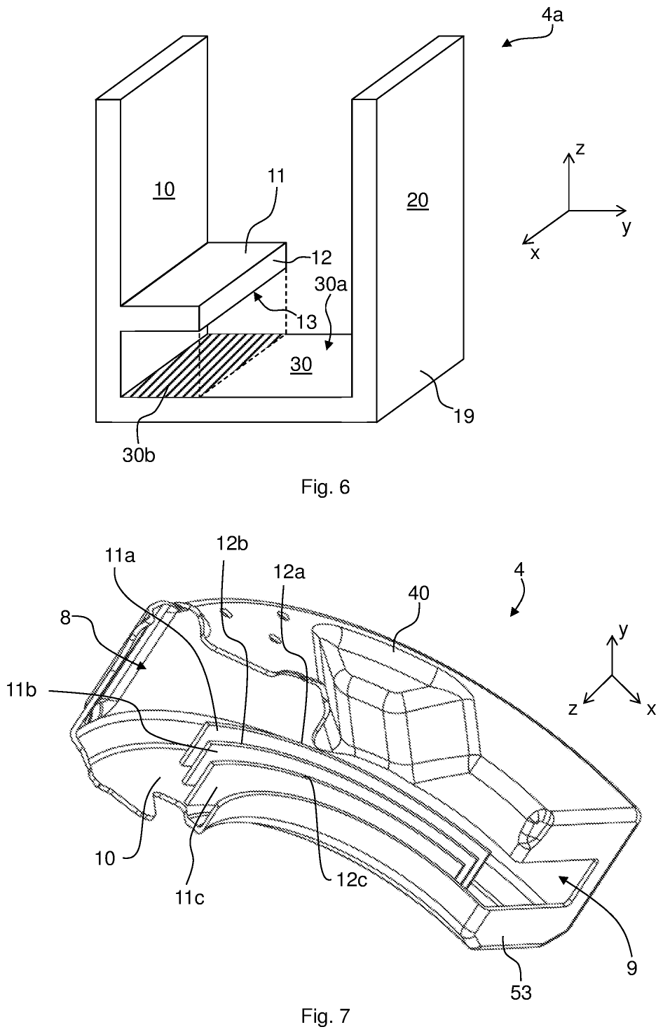

FIG. 5 and FIG. 6 show a brake dust particle filter 4a according to a second embodiment. The filter 4a has mostly the same characteristics as the filter 4 of FIGS. 1 to 4 described above and can also be used in the disc brake assembly 1.

A difference to the filter 4 of the first embodiment is that the filter 4a of the second embodiment has a more rectangular shape rather than a ring segment shape. On the interior 49 of the housing 19, a guiding element 11 is provided. The guiding element 11 is a blade which protrudes from the first side wall 10 towards the second side wall 20. The guiding element 11 comprises two faces 13, 13′ which are parallel to each other and normal to the first side wall 10 and a distal edge 12, which is here parallel to the first side wall 10. The distal edge 12 is here parallel to the second side wall 20 and located such that the brake disc 2 extends between the distal edge 12 and an interior face 20a of the second side wall 20.

The face 13 of the guiding element 11 is arranged opposite to an inner face 30a of a section 30b of the peripheral wall 30. The peripheral wall section 30b is a portion of the peripheral wall 30 which is adjacent to the first side wall section 10 from which the guiding element 11 protrudes. In FIG. 6, the peripheral wall section 30b is represented with stripes. In the example of FIGS. 5 and 6, the guiding element 11 extends over the entire longitudinal length of the housing 19. The guiding element 11, in particular its face 13, is parallel to the peripheral wall 30.

The guiding element 11 is used to deviate and guide the air flow from the openings 6 containing the dust particles. Thereby, the speed of the dust particles within the filter 4a is reduced and the probability that the particles encounter filter medium 43 while it is in the filter 4a is increased. Thereby, the efficacity of the filter 4a is improved.

Back to the first embodiment of the filter 4, FIG. 7 shows an interior of the housing 19 of the filter 4. The first side wall 10 of the filter 4 comprises three guiding elements 11a-11c protruding towards the second side wall 20. The guiding elements 11a-11c are substantially identical to the single guiding element 11 of the filter 4a of the first embodiment (FIGS. 5 and 6). A difference lies in the shape of the guiding elements 11a-11c, which is bent in the same manner as the entire filter 4.

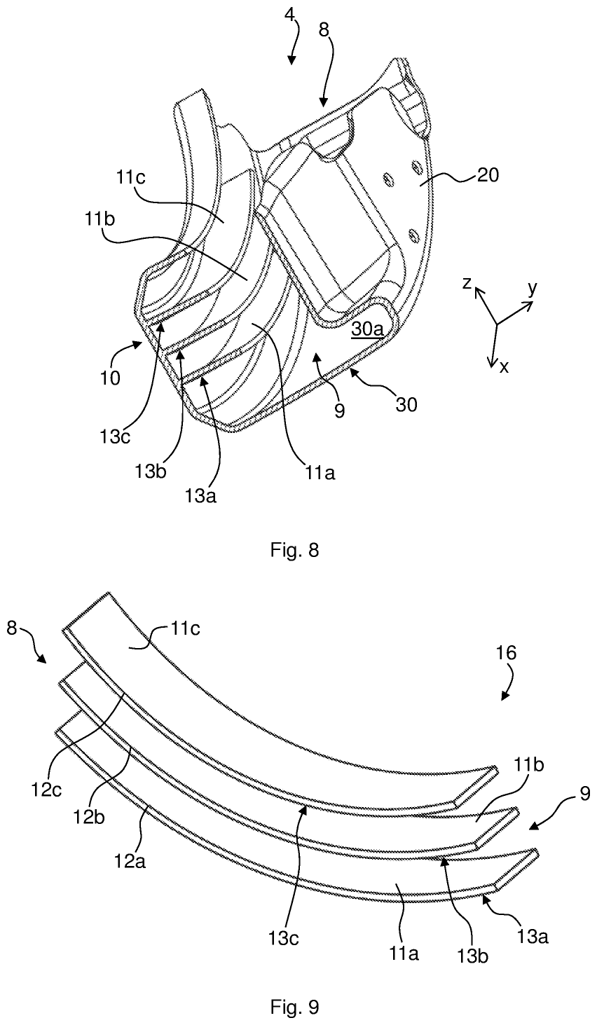

The bent shape of the guiding elements 11a-11c can be seen in FIGS. 8 and 9, wherein FIG. 8 shows another view of the filter 4 and FIG. 9 shows an element arrangement 16. Namely, the guiding elements 11a-11c are bent such that they respectively have a face 13a-13c which is arranged opposite to the interior face 30a of the peripheral wall 30, here in a parallel manner. The guiding elements 11a-11c thus also extend along a circumferential direction. Their respective distal edges 12a-12c all protrude towards the second side wall 20 in the same manner as the distal edge 12 of the filter 4.

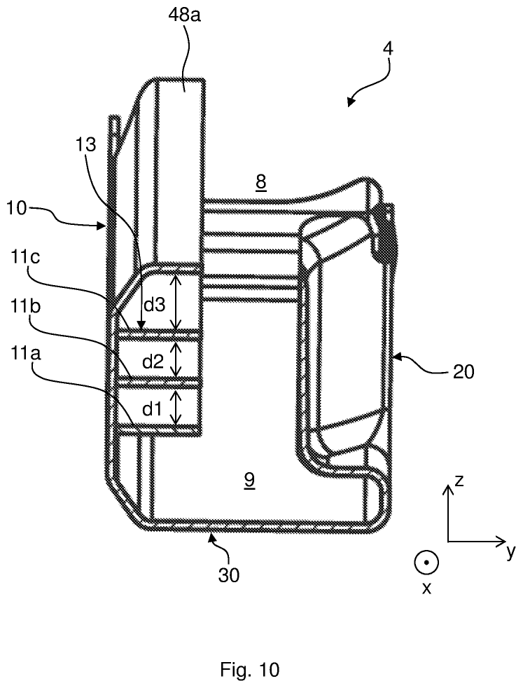

As shown in FIG. 7, the guiding elements 11a-11c all have a same length along their circumferential direction and are shorter than a total length of the first side wall 10 along the circumferential direction. As shown in the cut view of FIG. 10, a distance d1 between the guiding elements 11a and 11b, a distance d2 between the guiding elements 11b and 11c and a distance d3 between guiding element 11c and the additional peripheral wall portion 48 is not the same. The plurality of guiding elements 11a-11c allow deviating the particle flow and improving the filtering.

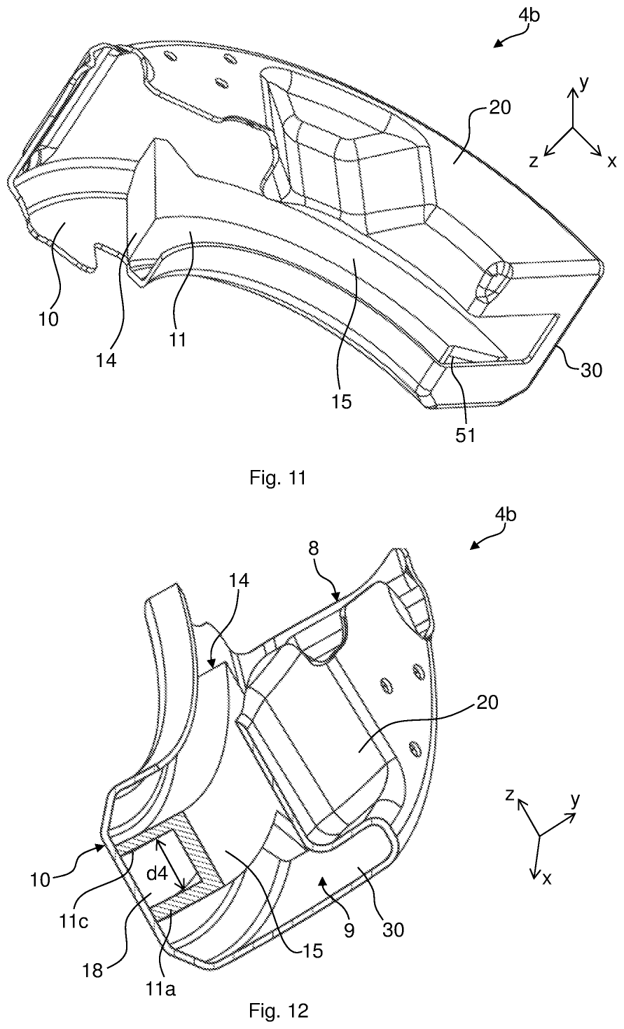

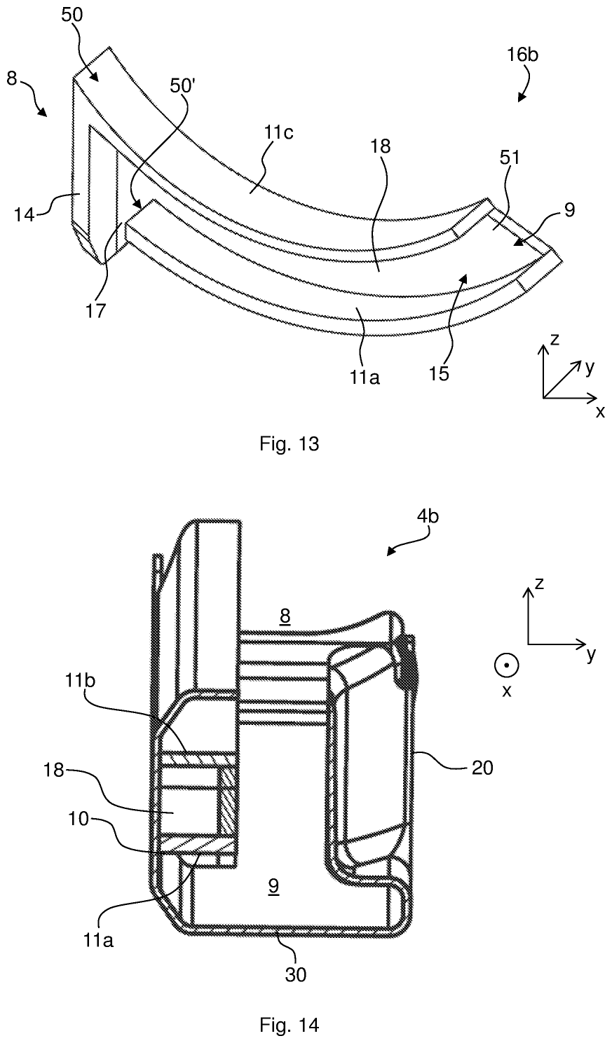

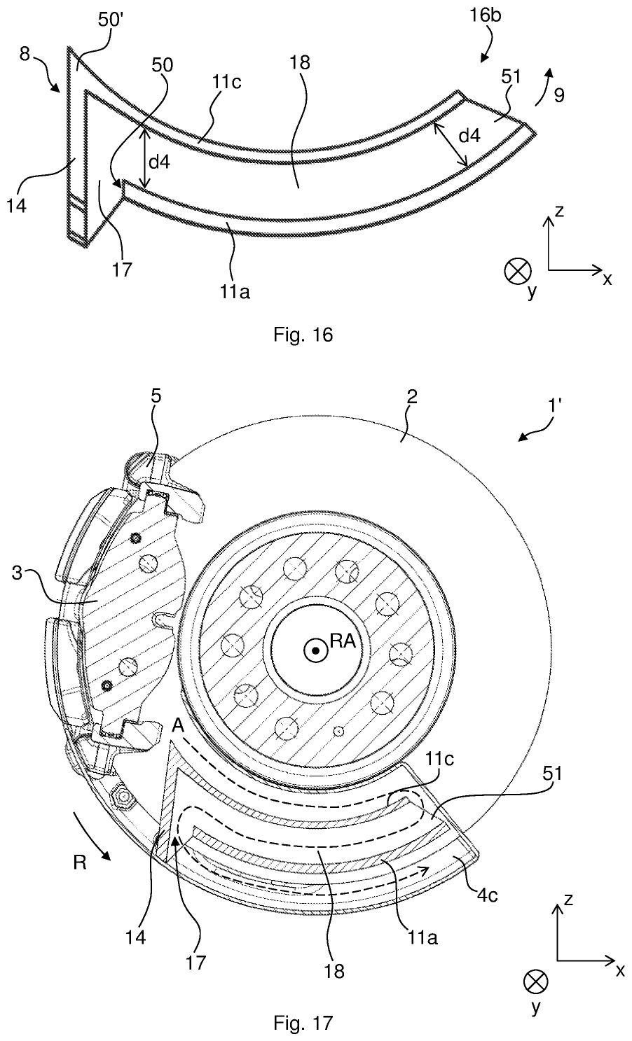

FIGS. 11 to 17 relate to a third embodiment of a brake dust particle filter 4b. The brake dust particle filer 4b differs from the filter 4 of the first embodiment only in that it comprises a different element arrangement 16b (FIG. 13). Namely, the filter 4b only comprises the two guiding elements 11a and 11c, but not the guiding element 11b. As shown in FIG. 16, the guiding element 11 is slightly shifted laterally with respect to the guiding element 11c, while maintaining a constant distance d4 between the two guiding elements 11a, 11c.

Further, the guiding elements 11a and 11c are connected by a partition element 15 which acts as a cover for the guide arrangement 16b (see FIG. 12). The partition element 15 is connected to the distal edges 12a and 12c of the guiding elements 11a and 11c. The partition element 15 extends parallelly to the first side wall 10 and along a radial direction of the disc brake assembly 1 in the mounted state. The partition element 15 partitions the housing interior 49 in two radial portions.

Further, as shown in FIG. 13, the element arrangement 16b of the filter 4b comprises a side element 14 which extends from a lateral edge 50 of the guiding element 11c (first guiding element) past a lateral edge 50′ of the guiding element 11a (second guiding element). Like the guiding elements 11a, 11c, the side element 14 also protrudes from the first side wall 10 towards the second side wall 20 on an interior 49 of the housing 19. The lateral edge 50 of the guiding element 11c from which the side element 14 extends may be a circumferential edge of the guiding element 11c on the side of the caliper side slot 8.

As shown in FIGS. 12 and 14, the guiding elements 11a and 11c, the side element 14 and the partition element 15 form a closed channel 18 for guiding the particles within the filter 4b. A channel opening 51 (FIG. 11 and FIG. 13) is provided on the side of the non-caliper side slot 9 on a radially inner portion of the filter 4b for releasing air from the channel 18. On the other side of the channel 18, a passage 17 is formed between the lateral edge 50′ of the guiding element and the side element 14. Particles enter the channel 18 through the passage 17.

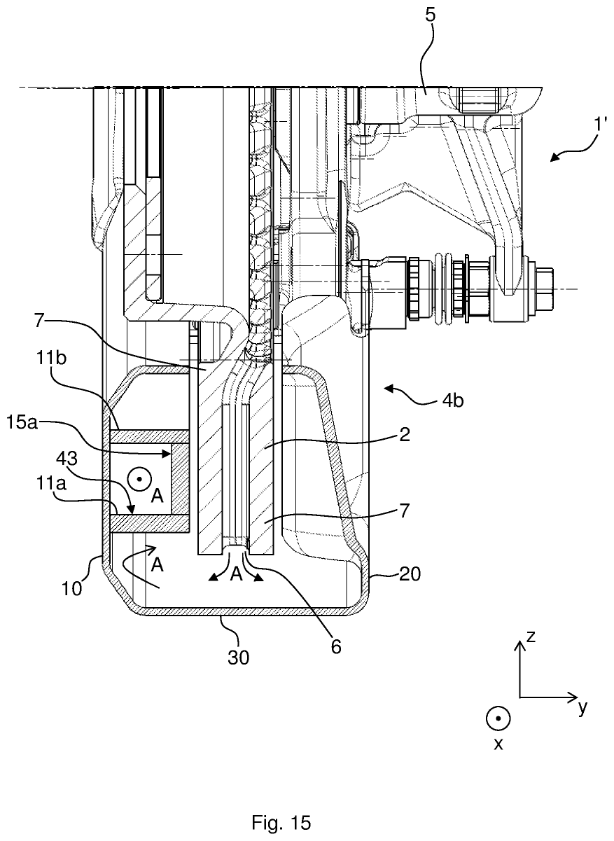

FIGS. 15 and 17 show a disc brake assembly 1′ according to a second embodiment with the brake dust particle filter 4b according to the third embodiment. FIG. 15 shows an air flow A of the air emitted from the openings 6 in the brake disc 2 and carrying the brake dust particles with it. As shown in FIG. 15, the air A is emitted radially from the openings 6 and deviated into an axial direction by the peripheral wall 30. The first side wall 10 and the guiding element 11a perform further deviations of the air A back towards the brake disc 2. The air A is slowed down by this process while being guided by the guiding element 11a towards the passage 17, through the channel 18 and out through the opening 51. On the way, the particles from the air flow A get collected by the filter medium 43 provided on the inside 49 of the housing 19, for example on all surfaces of the first side wall 10 and of the guiding elements 11a, 11c, of the side element 14 and of the partition element 15. The path of the air A is shown by a dashed line in FIG. 17. In some embodiments, the filter 4b comprises an opening to the outside for releasing air A to the outside.

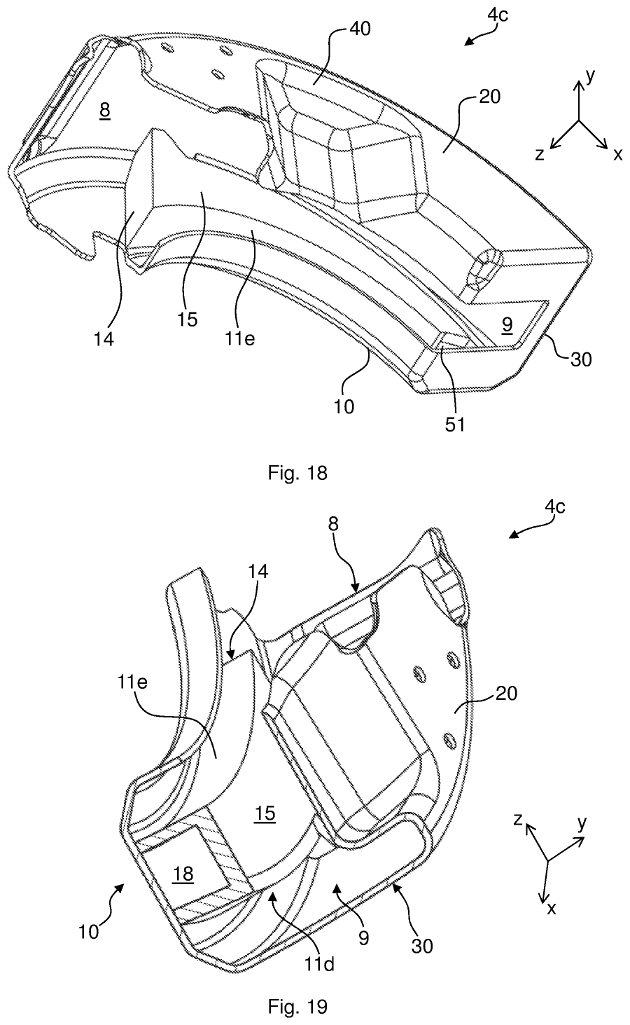

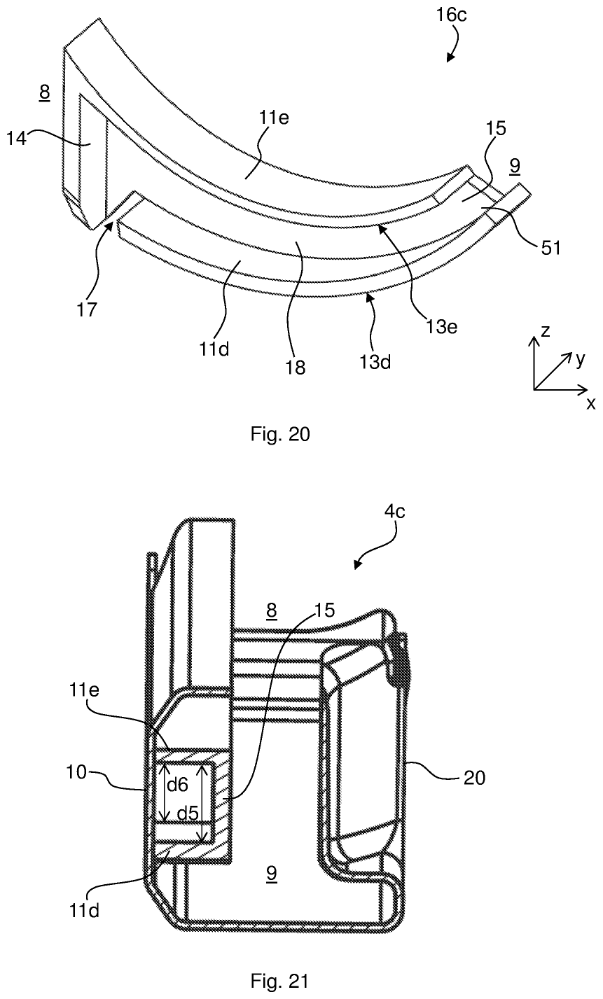

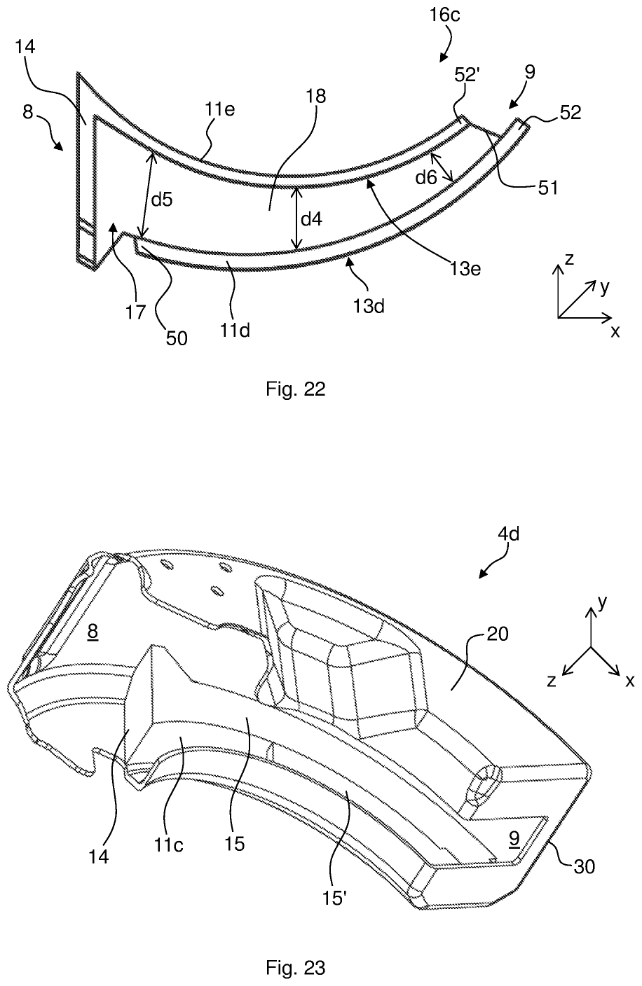

FIGS. 18 to 22 relate to a fourth embodiment of a brake dust particle filter 4c. The brake dust particle filer 4c strongly resembles to the filter 4b from the third embodiment, the only difference being that it comprises a different element arrangement 16c (FIGS. 20 and 22). Namely, the filter 4c only comprises two guiding elements 11d and 11e, which have their respective faces 13d and 13e which are arranged opposite to the interior 30a of the peripheral wall 30 without however being parallel thereto or to each other.

As shown in FIG. 22, a distance between opposite faces of the two adjacent guiding elements 11d, 11e becomes smaller as the distance to the side element 14 on the side of the caliper side slot 8 increases. In the example of FIG. 22, a distance d5 between the lateral edge 50 of the guiding element 11d and the guiding element 11e along a radial direction is larger than a distance d6 between lateral edges 52 and 52′ of the guiding elements 11d and 11e on the side of the channel opening 51. The width of the channel 18 along the radial direction thus decreases as one moves away from the brake caliper 3. This shape of the element arrangement 16c in the filter 4c allows a more directed guiding of the air flow with the brake dust particles.

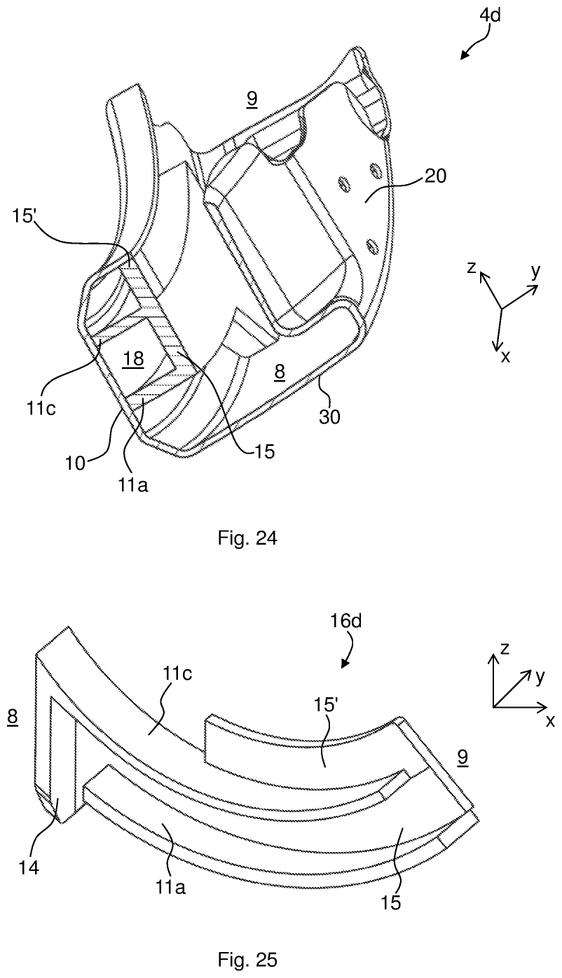

FIGS. 23 to 27 relate to a fifth embodiment of a brake dust particle filter 4d. The brake dust particle filer 4d strongly resembles to the filter 4b from the third embodiment, the only difference being that it comprises a slightly different element arrangement 16d (FIGS. 25 and 27). Namely, beyond the elements from the element arrangement 16b of the filter 4b of the third embodiment, the element arrangement 16d of the filter 4d additionally comprises an additional partition element 15′ which is continuous with the partition element 15 described above and extends away from the peripheral wall 30.

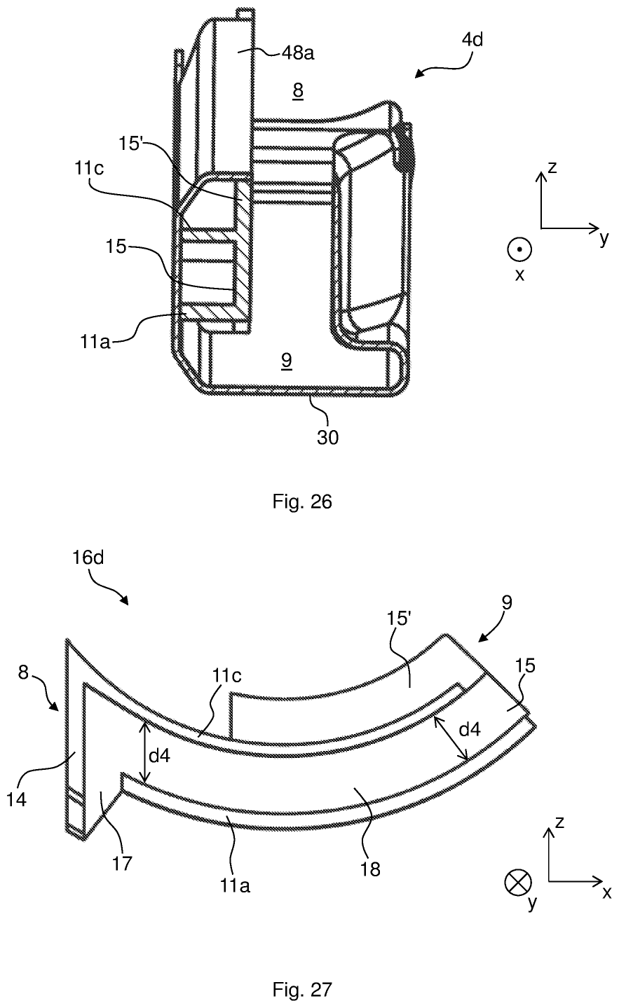

In detail, the additional partition element 15′ extends radially towards the additional peripheral wall portion 48a such as to connect with the additional peripheral wall portion 48a (FIG. 26). Circumferentially, the additional partition element 15′ only extends along a portion of guiding element 11c. In the filter 4d, the length of the path for the air A and particles is lengthened as compared to the length of the path in the filter 4b of the third embodiment, because the air A and particles are further guided by the additional partition element 15′.

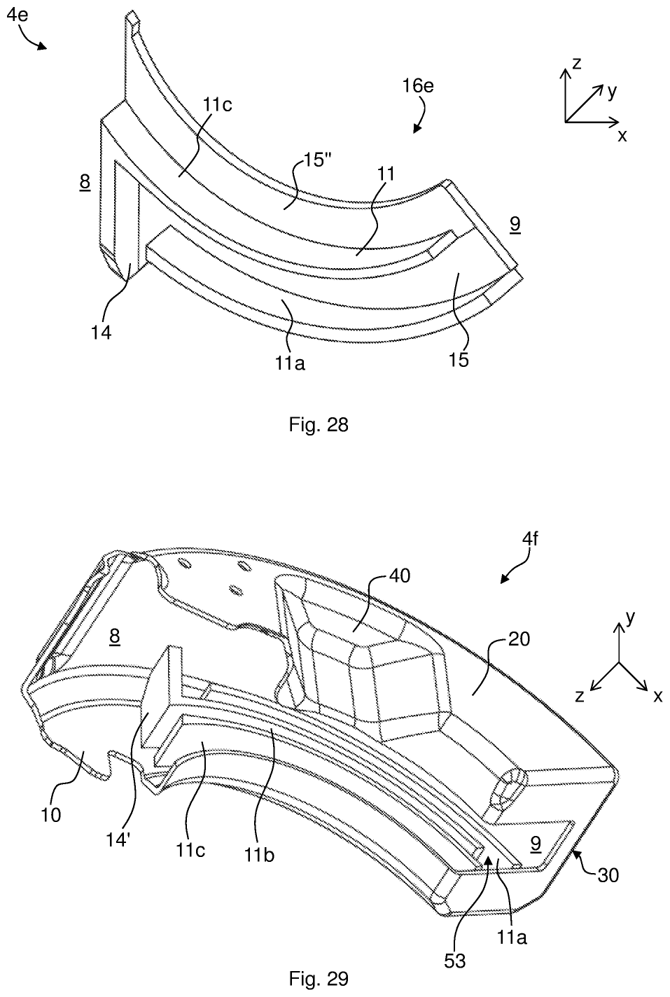

FIG. 28 relates to a sixth embodiment of a brake dust particle filter 4e, in which an element arrangement 16e differs from the element arrangement 16d of the filter 4d of the fifth embodiment only in that an additional partition element 15″ extends along the entire circumferential extension of the guiding element 11c. Thereby, the length of the particle channel 18 is increased even further as compared to the filter 4d of the fifth embodiment.

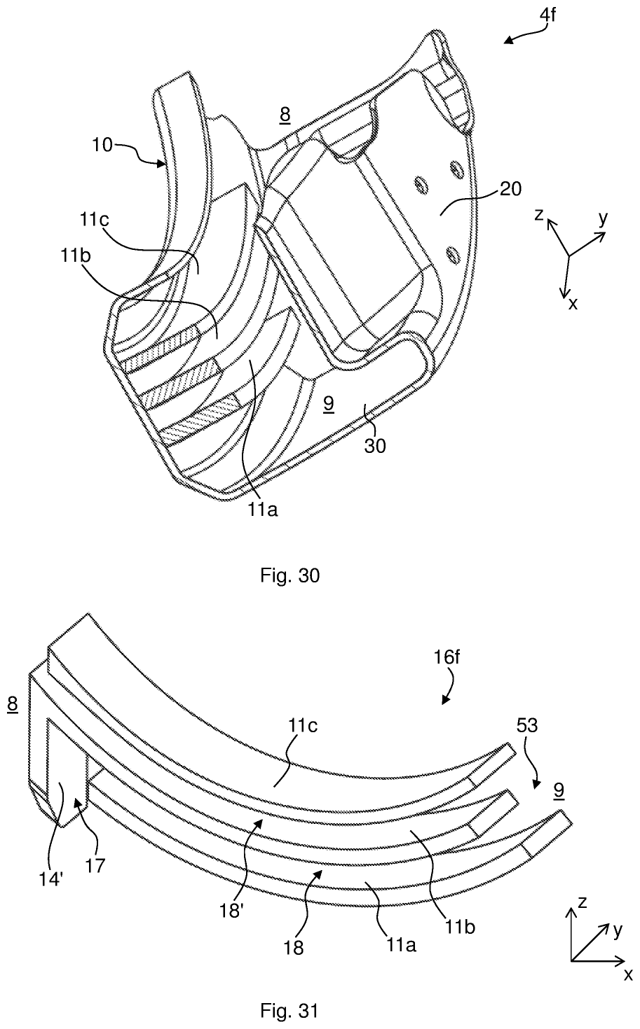

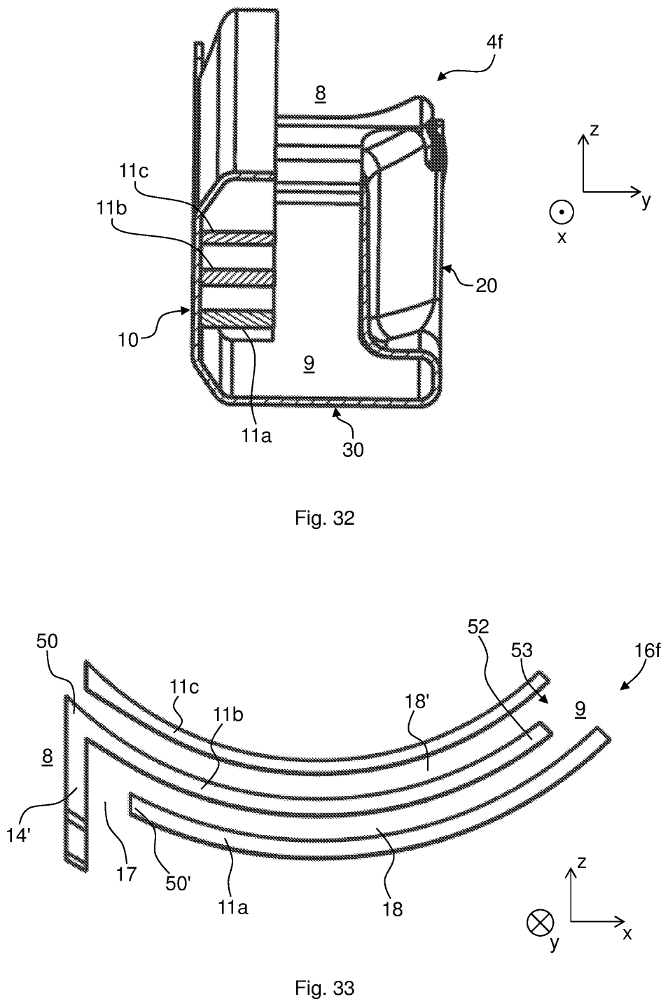

FIGS. 29 to 33 relate to a seventh embodiment of a brake dust particle filter 4f. The brake dust particle filer 4d resembles to the filter 4 of the first embodiment, the only difference being that it comprises a slightly different element arrangement 16f (FIGS. 31 and 33). Namely, like in the third embodiment, the element arrangement 16f of the filter 4e comprises a side element 14″ which extends from a lateral edge 50 of the guiding element 11b (first guiding element) past a lateral edge 50′ of the guiding element 11a (second guiding element). Like the guiding elements 11a-11c, the side element 14′ also protrudes from the first side wall 10 towards the second side wall 20 on an interior 49 of the housing 19. The lateral edge 50 of the guiding element 11b from which the side element 14″ extends may be a circumferential edge of the guiding element 11b on the side of the caliper side slot 8.

Further, the guiding element 11b is slightly shifted circumferentially towards the side of the caliper side slot 8 in order to create a further passage 53 between the lateral edge 52 of the guiding element 11b on the side of the non-caliper side slot 9 and a non-caliper side wall of the housing 19. The particle air flow A shown is lengthened through the labyrinth-like channel 18′, thereby contributing to the slowing down of the particles resulting from the brake process.

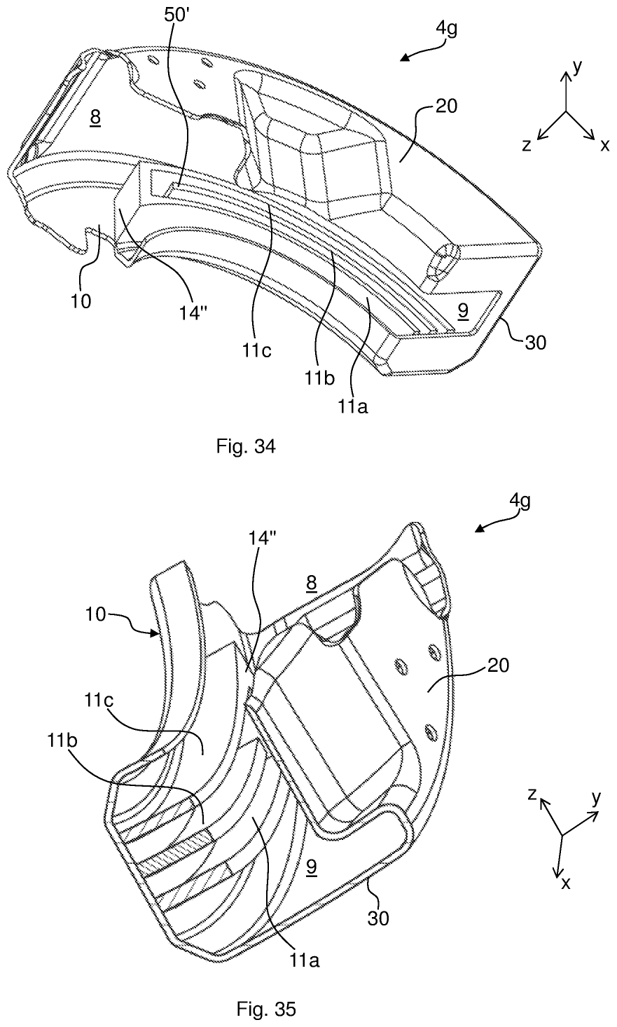

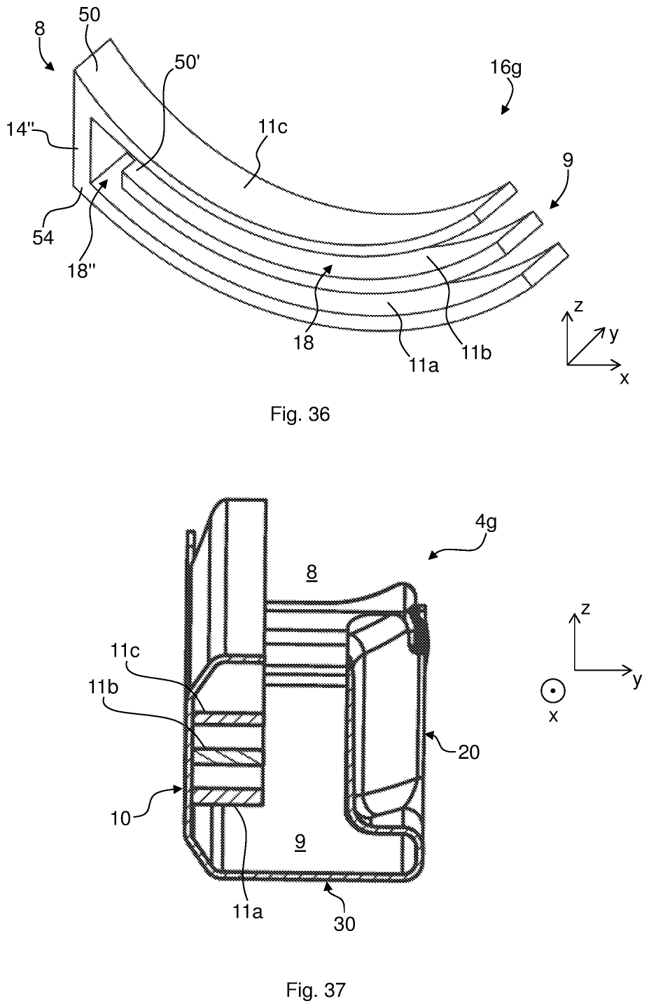

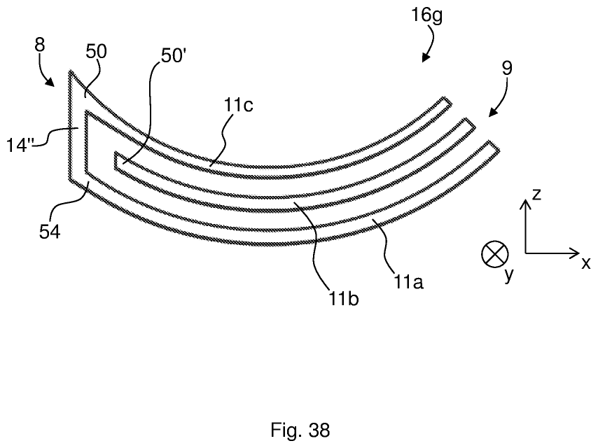

FIGS. 34 to 38 relate to an eighth embodiment of a brake dust particle filter 4g. The brake dust particle filer 4g resembles to the filter 4 of the first embodiment, the only difference being that it comprises a slightly different element arrangement 16g (FIGS. 36 and 38). Namely, similarly to the third embodiment, the element arrangement 16g of the filter 4g comprises a side element 14″ which extends from a lateral edge 50 of the guiding element 11c (first guiding element) past a lateral edge 50′ of the guiding element 11a (second guiding element). Like the guiding elements 11a-11c, the side element 14″ also protrudes from the first side wall 10 towards the second side wall 20 on an interior 49 of the housing 19. The lateral edge 50 of the guiding element 11b from which the side element 14 extends may be a circumferential edge of the guiding element 11b on the side of the caliper side slot 8.

The side element 14″ extends all the way towards a lateral edge 54 of the guiding element 11a on a side of the caliper side slot 8 so that it connects the guiding elements 11a, 11c at their lateral edges 50, 54. The element arrangement 16g thus forms a U-shaped path 18″ for guiding and collecting the particles.

Although the present invention has been described in accordance with preferred embodiments, it is obvious for the person skilled in the art that modifications are possible in all embodiments.

The number of guiding elements 11, 11a-11e may vary. Further, the distances between the guiding elements 11, 11a-11e and/or between the guiding element(s) 11, 11a-11e and the peripheral wall 30 may be chosen differently-. Additionally, the guiding elements 11, 11a-11e can have an interruption along a circumferential direction thereof and/or have portions with reduced protrusions along the radial direction. The housing 19 may comprise openings for releasing air and avoiding an overpressure.

The filters 4, 4a-4g may also comprise a guiding element(s) 11, 11a-11e, a side element 14, 14′, 14″ and/or a partition element 15, 15′, 15″ as described above, in particular to obtain a symmetric element arrangement 16, 16b-16g with respect to the brake disc 2.

### REFERENCE NUMBERS

1, 1′ disc brake assembly
2 brake disc
3 brake caliper
4, 4a-4g brake dust particle filter
5 caliper holder
6 opening
7a disc face
7b disc edge
8 caliper side slot
9 non-caliper side slot
10 first side wall
10a inner face of first side wall
11, 11a-11e guiding element
12, 12a-12c distal edge
13, 13′ 13a-13e guiding element face
14, 14′, 14″ side element
15, 15′, 15″ partition element
16, 16b-16g element arrangement
17 passage
18 channel
19 housing
20 second side wall
20a interior face of second side wall
30 peripheral wall
30a inner face of peripheral wall
30b peripheral wall section
40 bulge
42 brake pad
43 filter medium
44 wheel fixing portion
45 screw element
46 hydraulic system
47 slot
48 additional peripheral wall
48a, 48b additional peripheral wall portion
49 housing interior
50, 50′ lateral edge
51 channel opening
52, 52′, 54 lateral edge
53 passage
54 lateral wall
A air flow
d1-d6 distance
R forward rotation direction
RA rotation axis

1. A brake dust particle filter for a disc brake assembly with a brake disc and a brake caliper, the brake dust particle filter being configured to collect particles resulting from braking, and the brake dust filter comprising:
a housing comprising a first side wall and a second side wall that are arranged opposite to each other, and at least one peripheral wall or wall portion connecting the first side wall and the second side wall,
wherein the first side wall comprises at least one guiding element spaced radially from the at least one peripheral wall or wall portion protruding towards the second side wall within the housing, the at least one guiding element having a face arranged opposite to a peripheral wall section of the at least one peripheral wall,
the brake dust particle filter is further configured to accommodate the brake disc between a distal edge of the at least one guiding element and the second side wall, and
the first side wall and/or the second side wall comprises a plurality of guiding elements with a radial spacing inbetween.

2. The brake dust particle filter according to claim 1, wherein the peripheral wall section is adjacent to a first side wall section from which the at least one guiding element protrudes.

3. The brake dust particle filter according to claim 1, wherein the housing further comprises a housing interior is formed by the first side wall, the second side wall, the at least one peripheral wall or wall portion and at least one additional peripheral wall of the housing, and
the guiding element is arranged radially between the at least one peripheral wall and the additional peripheral wall.

4. The brake dust particle filter according to claim 1, wherein the face of the at least one guiding element extends in parallel to the peripheral wall section in a circumferential direction.

5. The brake dust particle filter according to claim 1, wherein the at least one guiding element has one among a bent shape, a circular shape, and a near circular shape.

6. The brake dust particle filter according to claim 1, wherein the housing has a ring segment shape,
the first side wall and the second side wall extend along a radial direction of the ring segment,
the at least one peripheral wall or wall portion extends along a circumferential direction of the ring segment, and
the at least one guiding element protrudes in an axial direction of the ring segment.

7. The brake dust particle filter according to claim 1, wherein the second side wall further comprises a guiding element protruding towards the first side wall, the guiding element of the second side wall having a face arranged opposite to a peripheral wall section of the at least one peripheral wall.

8. (canceled)

9. The brake dust particle filter according to claim 1, wherein a radial distance between adjacent faces from at least two of the at least one guiding element of the same side wall decreases along an extension of the at least one guiding element along a circumferential direction.

10. The brake dust particle filter according to claim 7, wherein the at least one guiding element of the first side wall flush with the at least one guiding element of the second side wall.

11. The brake dust particle filter according to claim 1, wherein the housing further comprises a partition element connecting at least two of the at least one guiding element, the partition element having a face arranged opposite to the first side wall such that a channel is formed between the first side wall, the partition element and the at least two of the at least one guiding element.

12. The brake dust particle filter according to claim 1, wherein the housing further comprises a partition element connecting the at least one guiding element and the at least one peripheral wall, the partition element having a face arranged opposite to the first side wall such that a channel is formed between the first side wall, the partition element, the at least one guiding element and the at least one peripheral wall.

13. The brake dust particle filter according to claim 11, wherein the partition element extends parallel to the first side wall.

14. The brake dust particle filter according to claim 3, wherein the first side wall further comprises a side element connected to a first guiding element and extending past a lateral edge of a second guiding element and/or the at least one peripheral wall and/or the at least one additional peripheral wall such as to form a passage between an end of the second guiding element and the side element of the first guiding element, the side element extending in a radial or near-radial direction.

15. The brake dust particle filter according to claim 14, wherein a distance from the peripheral wall section to the face of the first guiding element is larger than a distance from the peripheral wall section to the face of the second guiding element.

16. The brake dust particle filter according to claim 1, wherein a height of the first side wall corresponds to a radial extension of the housing, a distance between the at least one guiding element and the peripheral wall section being less than one third of a height of the first side wall.

17. The brake dust particle filter according to claim 3, further comprising a filter medium for collecting the particles, the filter medium extending at least on a part of the housing interior.

18. The brake dust particle filter according to claim 1, further comprising a slot for accommodating the brake disc in an installation state formed between the first side wall and the second side wall.

19. A disc brake assembly with the brake disc, the brake caliper and the brake dust particle filter according to claim 1,
wherein the brake disc extends between the distal edge of the at least one guiding element and the second side wall.

20. The disc brake assembly according to claim 19, wherein the brake dust particle filter is arranged in a fixed position relative to the brake caliper.

21. The disc brake assembly according to claim 19, wherein the brake disc is a ventilated disc comprising two disc faces and a circumferential edge with openings allowing an air flow therethrough, the openings in the edge being arranged opposite to the at least one peripheral wall.

22. (canceled)

23. (canceled)

24. (canceled)

25. (canceled)

26. (canceled)

27. (canceled)

28. (canceled)

29. (canceled)
